(19) United States
(12) Patent Application Publication
(10) Pub. No.: US 2024/0100656 A1
(43) Pub. Date: Mar. 28, 2024

(54) Ratchet Wrench

(71) Applicant: United Jumbo Co., Ltd., Long Khanh City (VN)

(72) Inventor: Hung-Chen Chen, Long Khanh City (VN)

(21) Appl. No.: 17/950,215

(22) Filed: Sep. 22, 2022

(51) Int. Cl. B25B 13/46

(52) U.S. Cl. CPC B25B 13/463

(57) ABSTRACT

A ratchet wrench has a force-applying arm and a working head connected to each other, the working head is formed with an insertion hole, the insertion hole is used for accommodating a driving member and a positioning member, the positioning member is injection-molded with plastic material, an external force is applied to the positioning member, the positioning member is deformed by the external force, so that the positioning member is assembled with the working head, and the driving member is positioned on the working head. Thereby, manufacturing cost is reduced, and components can be easily assembled.

### FIELD OF THE INVENTION

The invention relates to a ratchet wrench, and more particularly to a low-cost and easy-to-assemble ratchet wrench.

### BACKGROUND OF THE INVENTION

Taiwan Patent Publication No. 533951 (hereinafter referred to as '951) discloses an “Improved One-way Ratchet Wrench Structure”. The following description uses the component names and drawings of '951. Please refer to FIG. 1 of '951. The main body is provided with the accommodating portion being penetrated through, and the ring groove is disposed on the proximal upper end edge of the accommodating portion for the retaining ring to fasten the cover in the ring groove of the main body in order to limit the ratchet body in the accommodating portion.

As seen in FIG. 1 of '951, '951 needs to form the ring grooves on the main body and the cover respectively for assembling the retaining ring, but the two ring grooves must be processed by computer numerical control (CNC). Therefore, in addition to increasing manufacturing cost, capacity utilization rate is also greatly reduced.

Furthermore, the front perimeter of the cover of '951 is provided with one of the ring grooves for the retaining ring to be snapped into, and the other ring groove is provided on the proximal upper end edge of the accommodating portion for the retaining ring to be snapped into. Therefore, force must be applied to force the retaining ring to be snapped into the ring grooves in different positions. Thus, assembly difficulty is increased, and assembly speed is slowed down.

In addition, after the retaining ring of '951 fastens the cover into the ring groove of the main body to limit the ratchet body in the accommodating portion, if it is found that there is a problem with cooperation between the ratchet body and the stopper, and it is required to replace with spare parts, it is impossible to take out the retaining ring to replace the spare parts smoothly. Usually, the main body, the ratchet body and the stopper have to be scrapped altogether. Increase of scrapped parts will increase variable cost and manufacturing cost.

In addition, the ratchet wrench of '951 is only marked with dimensions by printing, laser or rolling. However, since there are many similar sizes between metric and imperial specifications, users still need to take time to identify whether it is metric or imperial specification, and then identify the required size, so it takes more time to find the ratchet wrench of the required specification and size each time.

### SUMMARY OF THE INVENTION

An object of the invention is to provide a ratchet wrench to solve the above-mentioned difficulties in the prior art.

A ratchet wrench provided according to one embodiment of the invention comprises a main body, an elastic member, a stopper, a driving member and a positioning member. The main body has a force-applying arm and a working head connected to each other, the working head is formed with a first insertion hole, a hole wall at one end of the first insertion hole is provided with a first concave portion annularly, an accommodating groove is formed toward a side wall of the first insertion hole. The elastic member is accommodated in the accommodating groove. The stopper is accommodated in the accommodating groove, a side wall of the stopper is formed with a plurality of first tooth portions. The driving member is accommodated in the first insertion hole, one end of the driving member is assembled on the first insertion hole, an outer wall of the driving member is provided with a plurality of second tooth portions annularly, the elastic member is elastically butted against the stopper, the first tooth portions of the stopper mesh with the second tooth portions of the driving member. The positioning member is injection-molded with plastic material, the positioning member is formed with a second insertion hole, the positioning member is assembled on another end of the driving member through the second insertion hole, an outer wall of the positioning member is provided with a second convex portion annularly, and the second convex portion of the positioning member is assembled on the first concave portion of the working head.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1 is a perspective view of a ratchet wrench of the invention;

FIG. 2 is an exploded view of the ratchet wrench of the invention;

FIG. 3 is a side view and a partial cross-sectional view of the ratchet wrench of the invention;

FIG. 4 is a partial enlarged view of FIG. 3 of the ratchet wrench of the invention;

FIG. 5 is a top view and a partial cross-sectional view of the ratchet wrench of the invention;

FIG. 6 is a partial enlarged view and a first combined view of FIG. 4 of the ratchet wrench of the invention; and

FIG. 7 is a partial enlarged view and a second combined view of FIG. 4 of the ratchet wrench of the invention.

### DETAILED DESCRIPTION OF THE PREFERRED EMBODIMENTS

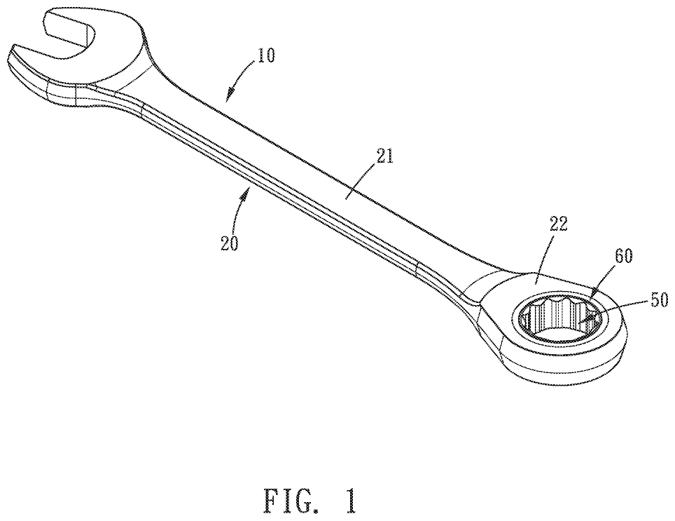

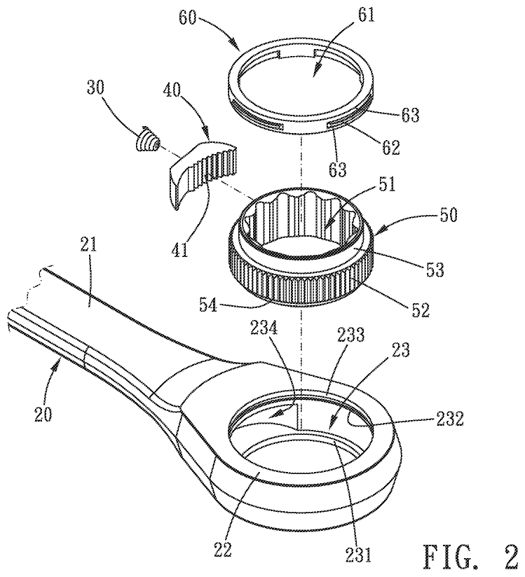

Please refer to FIGS. 1 and 2, the invention provides a ratchet wrench 10 comprising a main body 20, an elastic member 30, a stopper 40, a driving member 50 and a positioning member 60.

The main body 20 has a force-applying arm 21 and a working head 22 that are connected to each other. When the force-applying arm 21 is applied with a force, the working head 22 is actuated. The working head 22 is formed with an axially extending first insertion hole 23, and a hole wall at one end of the first insertion hole 23 axially is radially provided with a first convex portion 231 annularly.

Furthermore, a hole wall at another end of the first insertion hole 23 axially is radially provided with a first concave portion 232 annularly, the first convex portion 231 and the first concave portion 232 are spaced apart from each other by a distance, and a first blocking portion 233 is formed on hole walls on two sides of the first concave portion 232 respectively.

In addition, an arc-shaped accommodating groove 234 is radially recessed toward a side wall between the two ends of the first insertion hole 23, and the accommodating groove 234 is concavely formed from the working head 22 toward the force-applying arm 21. Moreover, the accommodating groove 234 is located on a side wall between the first convex portion 231 and the first concave portion 232.

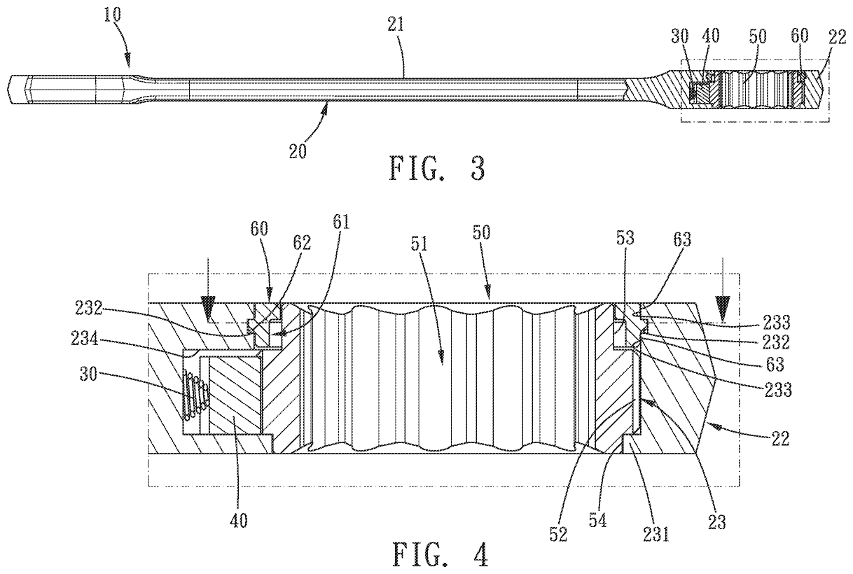

The elastic member 30 is a spring (please refer to FIGS. 2, 3, 4) or an elastic plate (not shown in the figures, which is integrally bent into a U-shape or a C-shape), and the elastic member 30 is accommodated in the accommodating groove 234.

A contour of the stopper 40 (please refer to FIGS. 2, 3, 4) is formed into an arc shape corresponding to an inner shape of the accommodating groove 234, so that the stopper 40 can be accommodated in the accommodating groove 234, one side as a convex side wall of the stopper 40 is elastically butted by the elastic member 30, and an opposite side as a concave side wall of the stopper 40 is formed with a plurality of first tooth portions 41.

The driving member 50 (please refer to FIGS. 2, 3, 4) is a hollow cylinder, an outer diameter of the driving member 50 is smaller than an inner diameter of the first insertion hole 23, so that the driving member 50 can be accommodated in the first insertion hole 23, one end of the driving member 50 is assembled on the first insertion hole 23, and one end of the driving member 50 is further assembled on the first convex portion 231. A central position of the driving member 50 is formed with an axially extending sleeve portion 51, the sleeve portion 51 penetrates the driving member 50, and the sleeve portion 51 can be a round hole, a quadrangular hole, a hexagonal hole or a hole in the shape of plum blossom. An outer wall between two ends of the driving member 50 is provided with a plurality of second tooth portions 52 annularly.

Furthermore, outer walls of the two ends of the driving member 50 axially are radially provided with second and third concave portions 53, 54 annularly, and the second tooth portions 52 are located between the second and third concave portions 53, 54, the third concave portion 54 at one of the ends of the driving member 50 is correspondingly assembled with the first convex portion 231 of the working head 22, and the elastic member 30 is elastically butted against the convex side wall of the stopper 40 with its own elastic force, causing the first tooth portions 41 of the concave side wall of the stopper 40 mesh with the second tooth portions 52 of the driving member 50. In addition, a depth of the second concave portion 53 is greater than a depth of the third concave portion 54, because a space needs to be reserved in the second concave portion 53 for accommodating the positioning member 60. Depth refers to radial depth and axial depth. Structures of the third concave portion 54 and the first convex portion 231 can be replaced with each other, and are not limited to concave and convex structures.

In addition, the elastic member 30 can be matched with a blind hole (not shown in the figures) under requirement of stable operation. One way is to form a blind hole (not shown in the figures) in a groove wall of the accommodating groove 234 for accommodating one end of the elastic member 30, and another end of the elastic member 30 is elastically butted against the convex side wall of the stopper 40. Another way is to form a blind hole (not shown in the figures) in the convex side wall of the stopper 40 for accommodating one of the ends of the elastic member 30, and the other end of the elastic member 30 is elastically butted against the groove wall of the accommodating groove 234.

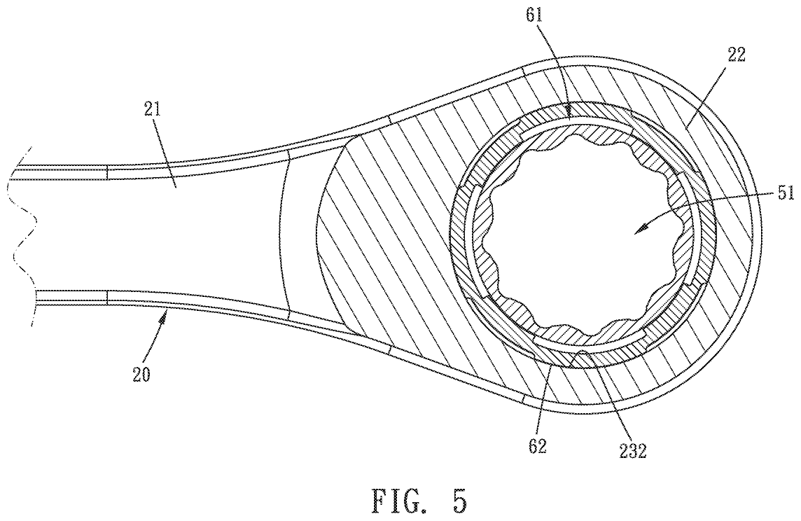

The positioning member 60 is injection-molded with plastic material, the positioning member 60 (please refer to FIGS. 2, 3, 4, 5) is a hollow annular body, the positioning member 60 is formed with a second insertion hole 61 extending axially, an outer wall between two ends of the positioning member 60 axially is radially provided with a second convex portion 62 annularly, the second convex portion 62 has a plurality of protruding ribs, the protruding ribs are spaced apart from one another, and outer walls of two sides of the second convex portion 62 are respectively formed with a second blocking portion 63.

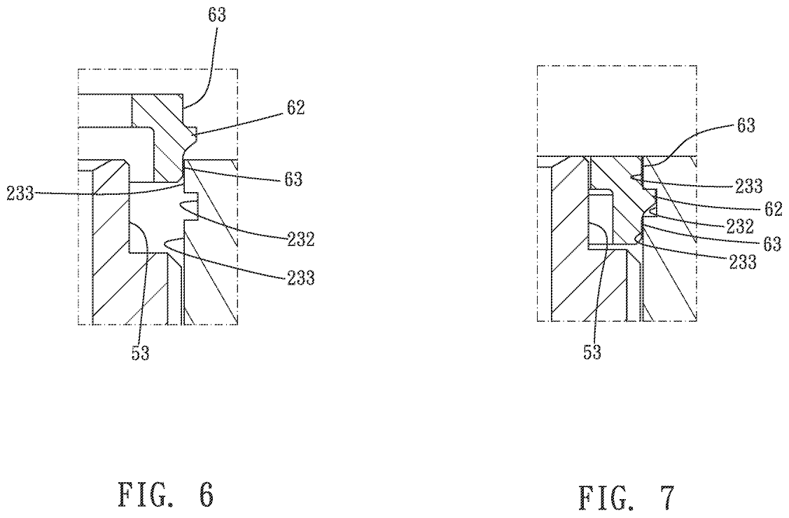

Please refer to FIGS. 4, 6, 7, an external force is applied to the positioning member 60, so that the positioning member 60 can be assembled on the second concave portion 53 at the other end of the driving member 50 through the second insertion hole 61. The positioning member 60 is deformed by the external force, so that the second convex portion 62 of the positioning member 60 is correspondingly assembled with the first concave portion 232 of the working head 22, and the first blocking portion 233 of the working head 22 and the second blocking portion 63 of the positioning member 60 abut against each other, so that the positioning member 60 is firmly combined with the working head 22. Structures of the second convex portion 62 and the first concave portion 232 can be replaced with each other, and are not limited to concave and convex structures.

The positioning member 60 further has a molding color for identification, and execution steps of the molding color comprise:
before injection molding of the positioning member 60, selecting a target color according to a specification of the ratchet wrench 10, for example, if the specification is imperial or metric, for the ratchet wrench 10 with an imperial specification, the positioning member 60 is marked in red, for the ratchet wrench 10 with a metric specification, the positioning member 60 is marked in blue;
during injection molding of the positioning member 60, performing a plastic dyeing according to the selected target color, the plastic dyeing is toner dyeing, pigment dyeing, full resin dyeing, or full grain dyeing; and
after injection molding of the positioning member 60, the positioning member 60 having the molding color, and adjusting the molding color by the plastic dyeing corresponding to the target color selected before plastic injection molding.

When an operator wants to select the ratchet wrench 10 with an appropriate specification, a color of the positioning member 60 can help the operator to quickly identify the specification. For example, when the metric ratchet wrench 10 uses the blue positioning member 60, the operator can distinguish the metric ratchet wrench 10 by the color of the positioning member 60, and select a correct size to be used accordingly, and then specifically select the size after identification by color, which can improve a speed at which the operator selects the specification of the ratchet wrench 10. Therefore, through the color of the positioning member 60 assisting in identifying specification, the operator can quickly select the ratchet wrench 10 with an appropriate specification, which is conducive to operation, saving time, and improving efficiency.

The invention provides the other ratchet wrench 10 (not shown in the figures), the difference is that the positioning member 60 is assembled at each of the ends of the driving member 50, the main body 20 does not use the first convex portion 231, but use the two first concave portions 232. Therefore, outer walls of two ends of the first insertion hole 23 of the main body 20 axially are radially provided with the two first concave portions 232 annularly, the two first concave portions 232 are spaced apart from each other by a distance, and hole walls on two sides of each of the first concave portions 232 are formed with the first blocking portion 233 respectively. The driving member 50 must also be adjusted in response to changes of the main body 20. Therefore, the second concave portion 53 and the third concave portion 54 at the two ends of the driving member 50 have a same depth, so that spaces can be provided at the two ends of the driving member 50 for accommodating the two positioning members 60. Besides the difference that the two positioning members 60 are provided instead of the single positioning member 60, structure and composition are the same, which will not be described again. The main body 20, the driving member 50 and the positioning member 60 are assembled in the same manner, which will not be described again.

In summary, the invention provides the ratchet wrench 10, the positioning member 60 adopts integral injection molding of the second convex portion 62, in the working head 22 of the main body 20, only the first concave portion 232 needs to be processed by high-cost computer numerical control (CNC), with the second convex portion 62 and the first concave portion 232 being assembled corresponding to each other, the positioning member 60 is capable of positioning the driving member 50 on the working head 22 of the main body 20. Therefore, in addition to reducing manufacturing costs, capacity utilization rate can be greatly improved.

Furthermore, the invention provides the ratchet wrench 10, the positioning member 60 is injection-molded with plastic material, and the second convex portion 62 is integrally injection-molded to match with the first concave portion 232. After the elastic member 30, the stopper 40 and the driving member 50 are assembled to the main body 20 in sequence, the plastic positioning member 60 is applied with force to be deformed, and then each component can be positioned on the working head 22 of the main body 20. Therefore, positioning can be performed in one time, assembly difficulty is reduced and assembly speed is accelerated.

Furthermore, the invention provides the ratchet wrench 10, the adopted positioning member 60 is injection-molded with plastic material, after the positioning member 60 positions each component on the working head 22 of the main body 20, if there is a problem with cooperation between the stopper 40 and the driving member 50, and it is required to replace with spare parts, at this time, the positioning member 60 can be forced out reversely in a destructive way, the positioning member 60 can be smoothly removed to enable replacement with spare parts, the main body 20, the stopper 40 and the driving member 50 do not have to be scrapped altogether. Reduction of scrapped parts will reduce variable cost and manufacturing cost.

In addition, the invention provides the ratchet wrench 10, the adopted positioning member 60 is injection-molded with plastic material, during a process, a color of the positioning member 60 can be adjusted by dyeing, so that the positioning member 60 has at least one color, through the color of the positioning member 60, specification can be instantly identified, and the operator can quickly select the ratchet wrench 10 with an appropriate specification, which is conducive to operation, saving time, and improving efficiency.

Therefore, through the structures of the above embodiments, the invention provides the low-cost, easy-to-assemble ratchet wrench. The invention further provides the ratchet wrench with features of simple maintenance and easy replacement and capable of effectively reducing manufacturing cost, reducing assembly difficulty, and accelerating assembly speed.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A ratchet wrench comprising:
a main body, the main body having a force-applying arm and a working head connected to each other, the working head being formed with a first insertion hole, a hole wall at one end of the first insertion hole being annularly provided with a first concave portion, the first insertion hole being formed with an accommodating groove toward a side wall;
an elastic member, the elastic member being accommodated in the accommodating groove;
a stopper, the stopper being accommodated in the accommodating groove, a side wall of the stopper being formed with a plurality of first tooth portions;
a driving member, the driving member being accommodated in the first insertion hole, one end of the driving member being assembled on the first convex portion, an outer wall of the driving member being provided with a plurality of second tooth portions annularly, the elastic member being elastically butted against the stopper, the first tooth portions of the stopper meshing with the second tooth portions of the driving member; and
a positioning member, the positioning member being injection-molded with plastic material, the positioning member being formed with a second insertion hole, the positioning member being assembled on another end of the driving member through the second insertion hole, an outer wall of the positioning member being annularly provided with a second convex portion, and the second convex portion of the positioning member being assembled on the first concave portion of the working head.

2. The ratchet wrench as claimed in claim 1, wherein a hole wall at another end of the first insertion hole is annularly provided with a first convex portion, the first convex portion and the first concave portion are spaced apart from each other by a distance, one of the ends of the driving member is further assembled on the first convex portion, the working head is formed with a first blocking portion respectively on hole walls of two sides of the first concave portion of the first through hole, the positioning member is formed with a second blocking portion respectively on outer walls of two sides of the second convex portion, the first blocking portion of the working head and the second blocking portion of the positioning member abut against each other, the second convex portion of the positioning member has a plurality of protruding ribs, the protruding ribs are spaced apart from one another, the accommodating groove is concavely formed from the working head toward the force-applying arm, the accommodating groove is located on a side wall between the first convex portion and the first concave portion, outer walls of the two ends of the driving member are provided with second and third concave portions annularly, the second tooth portions are located between the second and third concave portions, the third concave portion at one of the ends of the driving member is correspondingly assembled with the first convex portion of the working head, and the positioning member is assembled on the second concave portion at the other end of the driving member through the second insertion hole.

3. The ratchet wrench as claimed in claim 1, wherein a hole wall at another end of the first insertion hole is annularly provided with another first concave portion, the two first concave portions are spaced apart from each other by a distance, the working head is formed with a first blocking portion respectively on hole walls of two sides of the two first concave portions of the first through hole, the ratchet wrench further comprises another positioning member, the positioning member is injection-molded with plastic material, the positioning member is formed with a second insertion hole, the two positioning members are formed with a second blocking portion respectively on outer walls of two sides of the second convex portion, the first blocking portion of the working head and the second blocking portions of the two positioning members abut against one another, the second convex portion of the two positioning members has a plurality of protruding ribs, the protruding ribs are spaced apart from one another, the accommodating groove is concavely formed from the working head toward the force-applying arm, the accommodating groove is located on a side wall between the two first concave portions, outer walls of the two ends of the driving member are provided with second and third concave portions annularly, the second tooth portions are located between the second and third concave portions, and the two positioning members are respectively assembled on the second concave portion and the third concave portion of the driving member through the second insertion hole.

4. The ratchet wrench as claimed in claim 1, wherein a blind hole is formed in a groove wall of the accommodating groove, the blind hole is provided for accommodating one end of the elastic member, and another end of the elastic member is elastically butted against the side wall of the stopper.

5. The ratchet wrench as claimed in claim 1, wherein a blind hole is formed in the side wall of the stopper, the blind hole is provided for accommodating one end of the elastic member, and another end of the elastic member is elastically butted against a groove wall of the accommodating groove.

6. The ratchet wrench as claimed in claim 1, wherein the positioning member further has a molding color, execution steps of the molding color comprise:
before injection molding of the positioning member, selecting a target color according to a specification of the ratchet wrench;
during injection molding of the positioning member, performing a plastic dyeing according to the selected target color; and
after injection molding of the positioning member, the positioning member having the molding color, and adjusting the molding color by the plastic dyeing corresponding to the target color selected before plastic injection molding.

7. The ratchet wrench as claimed in claim 1, wherein the plastic dyeing is toner dyeing, pigment dyeing, full resin dyeing, or full grain dyeing.
